(19) United States
(12) Patent Application Publication
(10) Pub. No.: US 2009/0050170 A1
(43) Pub. Date: Feb. 26, 2009

(54) SHAVING SOLUTIONS FOR ELECTRIC SHAVING DEVICES

(76) Inventor: Milton D. MOORE, Houston, TX (US)

Correspondence Address: CONLEY ROSE, P.C.;David A. Rose, P. O. BOX 3267, HOUSTON, TX, 77253-3267, US

(21) Appl. No.: 12/196,837

(22) Filed: Aug. 22, 2008

Related U.S. Application Data
(60) Provisional application No. 60/957,927, filed on Aug. 24, 2007.

(51) Int. Cl. B26B 19/02; A61Q 9/02

(52) U.S. Cl. 132/200; 424/73

(57) ABSTRACT

A method for treating human skin comprising a shaving solution for electric shaving devices consisting of de-ionized water solution, low humidity humectant, propylene glycol, plant extract, panthenol, biological oil, and laureth-23. The method further comprising applying the shaving solution to the skin prior to shaving with an electric shaving device.

### REFERENCE TO RELATED APPLICATIONS

This application claims the benefit of provisional patent application No. 60/957,927 filed Aug. 24, 2007 entitled, “Shaving Solutions for Electric Shaving Devices” which is hereby incorporated herein by reference in its entirety for all purposes.

### STATEMENT REGARDING FEDERALLY SPONSORED RESEARCH OR DEVELOPMENT

Not applicable.

### BACKGROUND

1. Field of the Invention

This invention relates generally to the field of shaving products. More specifically, the invention relates to solutions and methods for shaving with electric shaving devices such as clippers and electric razors.

2. Background of the Invention

For conventional shaving with a safety razor or a straight razor, once the area to be shaved is wetted, a shaving soap or foam is applied in order to more fully hydrate the hairs. This procedure is followed both by men, when shaving the beard, and by women, when shaving legs, underarms, facial hair, or the bikini line. One disadvantage associated with shaving soaps and foams is that the hydration of the hairs is not complete, and thus they often do not lubricate well at the razor's edge. The razor can tend to stick, leading to nicks, cuts, or skin irritation. In addition, the soaps or foams tend to desiccate the skin, and creams or emollients must often be applied after shaving to re-hydrate the skin.

Moreover, shaving with electric clippers and electric razors necessitates different requirements than straight razor shaving. Presently, existing shaving solutions and compositions are not applicable to electric clippers and/or electric razors. No existing shaving products for electric shaving devices are available that hydrate and lubricate the skin. Instead, presently available products merely use alcohol to thicken the stubble for easier cutting.

Consequently, there is a need for methods and compositions for shaving with electric shaving devices.

### BRIEF SUMMARY

Methods and solution for shaving with electric shaving devices are disclosed herein. The methods and solutions incorporate the use of biological oils for superior lubrication. Other aspects and features of the invention will be described in more detail below.

In an embodiment, shaving solution for electric shaving devices comprises de-ionized water, propylene glycol, hydroxypropyl bis-hydroxyethyldimonium, aloe vera, biological oil and laureth-23.

In an embodiment, a method of shaving a human skin area using an electric shaving device comprises flooding the human skin area with an aqueous solution comprising of from about 0.2% to about 0.4% by volume of a biological oil in combination with propylene glycol and aloe vera as active ingredients and shaving the flooded skin area with an electric shaving device.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### DETAILED DESCRIPTION OF THE PREFERRED EMBODIMENTS

In an embodiment, the shaving solution includes one or more of the following ingredients: a biological oil, a de-ionized water solution, propylene glycol, a plant extract, panthenol, a humectant, and laureth-23.

In an embodiment, a shaving composition for use with electric shaving devices comprises from about 0.05% by volume to about 5% by volume oil, alternatively from about 0.1% to about 2.5% by volume oil, alternatively from about 0.2% to about 0.4% volume oil. The oil may be any natural or biological oil known to those of skill in the art. Examples of suitable oils include without limitation, canola oil, coconut oil, jojoba oil, palm oil, olive oil, safflower oil, vegetable oil, rapeseed oil, algae oil, or combinations thereof. Preferably, the biological oil is either canola oil or jojoba oil. The addition of the biological oil enhances the lubrication of the skin for shaving with the electric shaving device. In addition, the biological oil lubricates the blades used in the electric shaving device. Thus, using the disclosed shaving compositions not only provides superior hydration and lubrication for the skin, but also precludes the need for separate lubrication of the electric shaving device blades.

In an embodiment, the shaving composition is an aqueous solution such that the active ingredients are dissolved in a solvent. Preferably, the solvent is an aqueous solution, such as de-ionized water. The water typically comprises from 20% to about 80% by volume, alternatively from about 30% to about 70% by volume, alternatively from about 40% to about 60% by volume.

The shaving composition also comprises from about 25% to about 75% by volume propylene glycol, alternatively from about 35% to about 65% by volume propylene glycol, alternatively from about 45% to about 55% by volume propylene glycol.

In further embodiments, the shaving composition comprises a plant extract at a concentration ranging from about 0.25% to about 3% by volume, alternatively ranging from about 0.5% to about 2% by volume, alternatively ranging from about 0.75% to about 1.5% by volume. In certain instances, the plant extract comprises aloe vera, alternatively, the extract may comprise any know extract for treating skin.

Additionally, the shaving composition comprises panthenol at a concentration ranging from about 0.1% to about 2% by volume, alternatively ranging from about 0.25% to about 1% by volume, alternatively ranging from about 0.3% to about 0.8% by volume.

In additional embodiments, the shaving composition comprises a low humidity humectant. The humectant may comprise any hygroscopic compound suitable for skin treatment as known to one skilled in the art. In certain instances, the humectant is hydroxypropyl Bis-hydroxyethyldimonium chloride (Cola® moist 200). The humectant component of the solution comprises a concentration ranging from about 0.5% to about 5% by volume, alternatively ranging from about 1% to about 4.5% by volume, alternatively ranging from about 2% to about 3% by volume.

Other ingredients in the shaving composition may include without limitation, preservatives, emulsifiers, and the like. Germaben II is a preservative, in certain embodiments Germaben II comprises a concentration ranging from about 0.1% to about 1% by volume. Laureth-23 comprises a preferred emulsifier in the composition at a concentration ranging from about 1% to about 4% by volume.

In one embodiment, the shaving composition may comprise a foaming agent such that the shaving composition may be applied as a foam. However, it is also contemplated that the shaving composition may be applied as a gel. Embodiments of the shaving composition are odorless and colorless. Furthermore, embodiments of the shaving composition do not require removal from the skin after shaving using a towel or water. The shaving composition has the ability to dry by itself without the need for further removal from the skin.

In use, the area to be shaved is flooded with the solution of the shaving composition during application. The solution is preferably applied with an atomizer. The area is then shaved with any suitable electric shaving device. As used herein, electric shaving device refers to any device used to remove hair from the body such as without limitation, clippers, electric razors, and the like. Electric razors that may be used with the shaving compositions include without limitation, rotary-type electric razors and foil-type electric razors. In certain instances, the disclosed application enhances the action of the electric razor. The hair softened by the solution may be easier to cut, and the blades of the electric shaving device may be at least partially lubricated by the oils in the solution.

The solution of the invention provides better hydration of the hairs and lubrication of the skin than is achieved by conventional methods, such as using a shaving foam or soap in combination with water. This enhanced hydration increases the ease with which a razor cuts through the hairs and reduces nicks and cuts, which makes the solution and system of the present invention well suited for those suffering from mild forms of razor rash, or those having sensitive skin. To further illustrate various illustrative embodiments of the present invention, the following example is provided.

### EXAMPLES

A sample composition of an embodiment of the disclosed shaving composition is shown below in Table 1. The composition, shown in percent concentration by weight (% w/w), was used in a customer feedback and technical research study,

TABLE 1

| Ingredients | |
|---|---|
| A | % W/W |
| Di Water | 50.5 |
| Propylene Glycol | 40 |
| Cola moist 200 | 3 |
| Aloe Vera | 1 |
| DL-Panthenol %50 | 0.6 |
| Germaben II | 0.6 |
| Canola Oil | 0.3 |
| Laureth-23 | 4 |
| Total | 100 |

under the name Clipperglide. The initiation of the Clipperglide technical report is a prerequisite to expanding distribution of this product this product in order to collect user feedback, comparison information, and identify potential market opportunities. The purpose of this study was to determine if the use of Clipperglide causes oxidation during short term (24 hours) and long-term (30 days) exposure to stainless steel and carbon steel blades, identify similarities and differences between Clipperglide, other shaving gels, and clipper oils applied to haircut clippers as well as shaving razors, and to collect user feedback about the performance of Clipperglide in a professional salon and home use personal shaving environment.

### Materials:

The test included the following materials
(12) Various Salon Clippers/Trimmers
(3) Wahl® Color Pro Hair Cut Clipper with extra blade
(15) Gillette® Twin Head Disposable Razors
(2) Gillette® Fusion™ razors with (15) Disposable Cartridges
Plastic Cups, 3.25 oz
Soft Bristle Brush
Clipperglide, 4 oz (See Table 1) Lot: 1190920015
Andis® Clipper Oil, 4 oz (Petroleum Distillate); Lot: 4010212108
Wahl® Universal Clipper Oil, 0.5 oz (Petroleum Distillate) Lot: 4391779309
Gillette® Fusion™ HYDRA-GEL, 7 oz

### Test Procedure:

Disposable twin razors were divided into 3 groups of 5 each as in Table 2:

TABLE 2

| | |
|---|---|
| Group A1 | Control |
| Group A2 | Clipperglide |
| Group A3 | Fusion HYDRA-GEL |

Disposable Fusion cartridges were divided into 3 groups of 5 each as in Table 3:

TABLE 3

| | |
|---|---|
| Group B1 | Control |
| Group B2 | Clipperglide |
| Group B3 | Fusion HYDRA-GEL |

The Wahl electric clippers were divided into three separate groups as in Table 4:

TABLE 4

| | |
|---|---|
| Group C1 | Andis Clipper Oil |
| Group C2 | Clipperglide |
| Group C3 | Wahl Clipper Oil |

### Test 1: 24 Hour Exposure at Ambient Room Temperature:

The samples from Tables 1-3 above were placed into individual plastic cups (3.25 oz). The various lubricants were applied to the samples. After 24 hours, the samples from Tables 1 and 2 were rinsed for 15 seconds in warm water then examined for rust and particles. The samples from Table 3, clipper blades were examined for rust and particles. They were not subjected to a warm water rinse.

### Test 2: 30-Day Exposure at Ambient Room Temperature:

The samples from 1-3 above were placed into individual plastic cups (3.25 oz). The various lubricants were liberally applied to the samples. Every 10 days the samples were examined for rust and particulate; additional lubricant was applied (except Hydra-Gel groups A3 and B3). At the end of 30 days, the samples were removed from the cups. The blades and the cups were examined for particles. The excess residue was removed with a soft bristle brush, before examining the blades exposed to Hydra-Gel.

The samples from 5.3 above were placed into individual cups (3.25 oz). The various lubricants were liberally applied. Every 10 days the samples were examined for rust and particulate; additional lubricant was applied. At the end of 30 days, the clipper blades were removed from the cups and residue from each cup was examined.

### Test 3: Barber/Salon 30-Day Use:

Two barbers received Clipperglide to use in place of their regular clipper oils. The barbers received instructions to use Clipperglide on each of their 6 pair of clippers/trimmers in place of their original clipper oil. Weekly, the barbers recorded their frequency of use along with their observations in several areas including:
Ease of Use
Sound/Noise Reduction
Smooth Cut/No Pulling
Most favorable attribute
Improvement recommendations
Overall Performance

### Test 4: Home Use 30-Day Shaving Experience:

Three males (age 27, 40, and 45) were given Clipperglide to shave with in place of their regular shaving solution. Each person shaved at least three times per week. Week 1, they were instructed to spray Clipperglide directly to the shaving surface. Week 2, they were instructed to spray Clipperglide into their hands and then apply to the shaving surface. Week 3 and week 4, they were given the option on how to apply Clipperglide. The participants were asked to evaluate Clipperglide in the following areas:
Ease of Use
Sound/Noise Reduction
Smooth Cut/No Pulling
Most favorable attribute
Improvement recommendations

### Results:

There were no signs of rust or particulate build up after the Test 1, 24-hour exposure experiments, as shown in Table 5:

TABLE 5

| | Rust on | Particulate | |
|---|---|---|---|
| | Blade | on Blade | Comments |
| Group A1 | No | No | |
| Group A2 | No | No | |
| Group A3 | No | No | Lubrication strip |
| | | | separated during |
| | | | water rinse |
| Group B1 | No | No | |
| Group B2 | No | No | |
| Group B3 | No | No | |
| Group C1 | No | No | |
| Group C2 | No | No | |
| Group C3 | No | No | |

Table 6 shows the following tabulated results reflect the investigators observations over Test 2, after a 10-day exposure period:

TABLE 6

| | Rust on | Particulate | |
|---|---|---|---|
| | Blade | on Blade | Comments |
| Group A1 | No | No | |
| Group A2 | No | No | |
| Group A3 | N/A | N/A | Gel/foam around blade |
| Group B1 | No | No | |
| Group B2 | No | No | |
| Group B3 | N/A | N/A | Gel/foam around blade |
| Group C1 | No | No | |
| Group C2 | No | No | |
| Group C3 | No | No | |

Table 7 shows the following tabulated results reflect the investigators observations over Test 2, after a 20 day exposure period:

TABLE 7

| | Rust on | Particulate | |
|---|---|---|---|
| | Blade | on Blade | Comments |
| Group A1 | No | No | |
| Group A2 | No | No | Slight separation of |
| | | | lubrication strip |
| Group A3 | N/A | N/A | Gel/foam around blade |
| Group B1 | No | No | |
| Group B2 | No | No | |
| Group B3 | N/A | N/A | Gel/Foam around blade |
| Group C1 | No | No | |
| Group C2 | No | No | |
| Group C3 | No | No | |

Table 8 shows the following tabulated results, that reflects the investigators observations over Test 2, after the total 30 day exposure period:

TABLE 8

| | Rust on | Particulate | |
|---|---|---|---|
| | Blade | on Blade | Comments |
| Group A1 | No | No | |
| Group A2 | No | No | Slight lubrication strip |
| | | | separation |
| Group A3 | No | YES | Heavy particulate on blade |
| Group B1 | No | No | |
| Group B2 | No | No | |
| Group B3 | No | YES | Heavy particulate on blade |
| Group C1 | No | No | |
| Group C2 | No | No | Small particles on blade |
| Group C3 | No | No | |

Table 9 shows the following results from Test 3 that reflects the feedback from professional salons and barbers after the total 30-day trial period. Note the bolded and underlined selections were made by the survey participant.

TABLE 9

| Questions | Participant #1 | Participant #2 |
|---|---|---|
| How does Clipperglide | Better - Same - Worse - | Better - Same - Worse - |
| compare to other oils for | Unknown - | Unknown - |
| “ease of use”? | | |
| How does Clipperglide | Better - Same - Worse - | Better - Same - Worse - |
| compare to other oils for | Unknown - | Unknown - |
| “sound/noise | | |
| reductions”? | | |
| How does Clipperglide | Better - Same - Worse - | Better - Same - Worse - |
| compare to other oils for | Unknown - | Unknown - |
| smooth cut/no pulling? | | |
| How does Clipperglide | Better - Same - Worse - | Better Same Worse |
| compare to other oils in | Unknown - | Unknown - |
| “overall performance”? | | |
| Would you recommend | Yes - No - Don't know - | Yes - No - Don't know |
| Clipperglide to others? | | |
| Do you prefer | Yes - No - Don't know - | Yes - No - Don't know |
| Clipperglide over other | | |
| oils you have used | | |
| Would you be willing to | Yes - No - Don't know - | Yes - No - Don't know |
| pay more for | | |
| Clipperglide? | | |
| What do you Like most | 1. Easy application | 1. Does not drip |
| about Clipperglide? | 2. Does not drip everywhere | 2. Easy to apply |
| | 3. I'm ready to throw my other | 3. Better than foam for doing |
| | oil away! | straight edge razor lines on |
| | | customers |
| Do you have any | NO | NO |
| improvement | | |
| suggestions? | | |

Additional information provided by the barber included the fact that on average, clipper oil purchased once per month and costs $1.99/bottle (4 oz). Additionally, sticking blades, heated blades, and pulling hair are indications that clipper need servicing and/or lubrication such as oil. In certain cases, replacement clipper blades are purchased once per year due to breakage and rust. On a busy day, each barber services about 30 clients, the clippers are cleaned with spray disinfectant, and lubricated with oil between each customer.

Table 10 shows the feed back received during Test 4, the 30-day home use. Survey participants were instructed to rate Clipperglide on a scale (1 to 5) in the following categories: 1=Poor, 2=Needs Improvement, 3=Fair, 4=Very Good, and 5=Excellent.

TABLE 10

| | Participant #1 | Participant #2 | Participant #3 |
|---|---|---|---|
| Category | Age 25 | Age 40 | Age 45 |
| Ease of Use | 4 | 5 | 5 |
| Smooth Cut/(pulling) | 5 | 4 | 5 |
| Close/clean cut | 4 | 4 | 4 |
| Fragrance | 3 | 2 | 3 |
| Cleaning | 4 | 5 | 4 |
| Most favorable | Easy to apply | No messy | Very smooth |
| attribute | and wipe off | foam on | shave |
| | | face and razor | |
| Application preference | Spray-on face | Spray-on face | Spray-on face |
| (spray on face or into | | | |
| hands) | | | |
| Improvement | Make thicker | Add cologne | None |
| recommendations | | | |

### Conclusions:

For Test 1, the data confirms that Clipperglide, in experimental groups A2 and B2, in comparison to Hydra-Gel, in experimental groups A3 and B3, produces less blade particulate on disposable shaving cartridges during short term and long-term exposure to shaving lubricants. This is a significant point, as blade particulate relates to blade performance, such as shaving effectiveness. For the electric clippers there was no observed difference in particulate for Clipperglide as in experimental group C2 and the other clipper oils, Andis® in group C1 and Wahl® in group C3. No rust was observed in any of the test groups.

The data from Test 2 confirms that professional participants in salons and barbers, in this study, preferred Clipperglide to other clipper oils for several benefits noted in Table 9. For statistical significance, the testing procedure is in the process of expanding the study to a larger population.

On average, test participants in Test 3, that used Clipperglide in place of their regulation shaving solutions, rated the product very high in all categories as illustrated in Table 10. This screening study produced promising results. For statistical significance, consider altering and expanding the study to a larger population.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims. The discussion of a reference in the Description of the Related Art is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

We claim:

1. A shaving solution for electric shaving devices comprising a de-ionized water solution, a low humidity humectant, propylene glycol, a plant extract, panthenol, a biological oil, and laureth-23.

2. The shaving solution of claim 1 wherein the de-ionized water solution comprises a concentration from about 20% to about 80% by volume.

3. The shaving solution of claim 1 wherein the de-ionized water solution comprises a concentration from about 40% to about 60% by volume.

4. The shaving solution of claim 1 wherein the low humidity humectant comprises a concentration from about 0.5% to about 5% by volume.

5. The shaving solution of claim 1 wherein the low humidity humectant comprises a concentration from about 2% to about 3% by volume.

6. The shaving solution of claim 1 wherein the low humidity humectant comprises a hydroxypropyl bis-hydroxyethyldimonium chloride solution.

7. The shaving solution of claim 1 wherein the propylene glycol comprises a concentration ranging from about 25% to about 75% by volume.

8. The shaving solution of claim 1 wherein the plant extract comprises aloe vera.

9. The shaving solution of claim 1 wherein the plant extract comprises a concentration ranging from about 0.25% to about 3% by volume.

10. The shaving solution of claim 1 wherein the panthenol comprises a concentration ranging from about 0.1% to about 1% by volume.

11. The shaving solution of claim 1 further comprising at least one supplemental component chosen from the group consisting of preservatives, emulsifiers, atomizers or combinations thereof.

12. The shaving solution of claim 11, wherein the at least one supplemental component comprises a concentration between at about 0.1% and about 4% by volume.

13. The shaving solution of claim 11 wherein the preservatives comprise Germaben II.

14. The shaving solution of claim 11 wherein the emulsifiers comprise Laureth-23.

15. The shaving solution of claim 1 wherein the biological oils comprise at least one chosen from the group consisting of canola oil, coconut oil, jojoba oil, palm oil, olive oil, safflower oil, rapeseed oil, algae oil, vegetable oil, and combinations thereof.

16. The shaving solution of claim 1 wherein the biological oils comprise a concentration ranging from about 0.2% to about 2% by volume.

17. The shaving solution of wherein the solution comprises of:
de-ionized water at a concentration ranging from about 40% to about 60% by volume;
propylene glycol at a concentration ranging from about 45% to about 55% by volume;
hydroxypropyl bis-hydroxyethyldimonium chloride at a concentration ranging from about 0.5% to about 0.7% by volume;
aloe vera at a concentration ranging from about 0.5% to about 1.5% by volume;
panthenol at a concentration ranging from about 0.5% to about 0.7% by volume;
canola oil at a concentration ranging from about 0.2% to about 0.4% by volume; and
laureth-23 at a concentration ranging from about 3% to about 5% by volume.

18. A method of shaving a human skin area using an electric shaving device comprising:
applying an aqueous shaving solution of a de-ionized water solution, a low humidity humectant, propylene glycol, a plant extract, panthenol, a biological oil, and laureth-23 to the human skin area; and
shaving the human skin area with an electric shaving device.

19. The method of claim 18 wherein applying the solution comprises spraying an atomized solution onto the human skin area.

20. A shaving solution for electric shaving devices comprising a de-ionized water solution and a biological oil.
